(19) United States
(12) Patent Application Publication
(10) Pub. No.: US 2021/0152078 A1
(43) Pub. Date: May 20, 2021

(54) PORTABLE VOLTAGE CONVERTER

(71) Applicant: KUANG-HAO LEE, Dongguan City (CN)

(72) Inventor: KUANG-HAO LEE, Dongguan City (CN)

(73) Assignee: DongGuan AHOKU Techland Electronics Ltd.

(21) Appl. No.: 16/686,225

(22) Filed: Nov. 18, 2019

(51) Int. Cl. H02M 1/32; H02M 5/257; H01R 31/06

(52) U.S. Cl. CPC H02M 1/32; H01R 31/065; H02M 5/257

(57) ABSTRACT

A portable voltage converter comprises a casing, an AC input and an AC output, and a voltage conversion circuitry; the AC input is connected to the voltage conversion circuitry, the input voltage is convened by the voltage conversion circuitry and connected to the AC output; the voltage conversion circuitry includes a low power voltage conversion circuitry and a high power voltage conversion circuitry; the low power voltage conversion circuitry has a core transformer, the operating current circuitry includes a current overload protector, the voltage waveform after voltage conversion is called the first waveform. The high power voltage conversion circuitry has a TRIAC, the voltage waveform after voltage conversion is called the second waveform. When the required power for the connected external load is high, the current overload protector reduces the output of the first waveform, so that the second waveform is actuated and output.

### BACKGROUND OF INVENTION

### 1. Field of the Invention

The present invention relates generally to the technical field of electronics and power, it is a portable voltage converter.

### 2. Description of Related Art

The traveling step-down voltage converters 220 VAC-to-110 VAC available on the market generally include three types: (1) traditional silicon steel sheet (EI) or magnetic core transformer; (2) switching circuit voltage converter composed of a bidirectional thyristor (TRIAC) as major electronic part, (3) mixed voltage converter composed of the foresaid two voltage converters.

For convenient carrying and use, general traveling step-down voltage converters are required of lightness thinness, shortness and smallness

Therefore, if a traveling step-down voltage converter is composed of traditional silicon steel sheet (EI) or magnetic core transformer, its output voltage waveform and input voltage waveform will have the same sine wave. Considering the portability for travelers, the weight and size are the key point, a small wattage voltage converter less than 200 W is generally selected. Therefore, it is applicable to low power consuming electronic products. This kind of voltage converter is abbreviated to low wattage voltage converter in the following text.

If the traveling step-down voltage converter is the switching circuit voltage converter composed of the TRIAC as major electronic part, it is light, thin, short and small, and it can bear a higher consumption power, but its output voltage waveform is non-sine wave, the peak output voltage is even same as the peak of input voltage, so it is not suitable to use with the voltage-sensitive electronic products, this kind of voltage converter is suitable for heating electronic products, e.g. hair dryers. This kind of converter is abbreviated to high wattage voltage converter in the following text. For example, the invention patent of U.S. Pat. No. 5,589,760 (inventor: Anthony Lee) discloses a traveling voltage converter, which uses a TRIAC to cut the waveform of high voltage (220V), so that the output power behaves as 110V, it is applicable to 110V traveling products, e.g. hair dryers, the 220V power can be used by the products designed using this technology, but the products designed using this technology are inapplicable to low power traveling products.

The mixed voltage converter composed of the former two voltage converters has the characteristics of the two converters. This kind of mixed converter is generally provided with manual two-step or three-step optional switch, or the operating current is detected automatically to drive the Relay to select low wattage transformer, high wattage converter or high-and-low wattage converter. For example, Anthony Lee designed another patent, besides the voltage transformation function of TRIAC, this U.S. Pat. No. 5,159,545 has a function of the core transformer. The product is divided into high power output and low power output, manual switch is performed by selector button, the operation is inconvenient with big size.

The manual two-step or three-step optional switch has the following two major defects: (1) if low wattage transformer is selected, but the output is connected to a high power product, this low wattage transformer will be damaged; (2) if the high wattage converter is selected, but the output is connected to a voltage-sensitive electronic product, this electronic product may be burnt. For example, U.S. Pat. No. 9,972,955 B1, inventor Vito Carlucci, title: travel voltage converter and adapter, the disclosed technology uses a three-step toggle switch, the contact position of toggle switch is shifted to implement three steps of output powers. However, the users easily switch the three steps incorrectly and misuse.

The major defect in automatic detection of operating current to drive the relay to select low wattage transformer or high wattage converter is the application of relay, current detection part and other electronic parts, so the size is bulky, and the large number of electronic components consumes a lot of manpower, the cost is high.

In view of this, the present invention proposes the following technical proposal.

### SUMMARY OF THE INVENTION

The purpose of the present invention is to overcome the deficiencies in the existing technology to provide a portable voltage converter.

In order to solve the above problems, the technical scheme of the present invention is described below:

1. A portable voltage converter, comprising

a casing, an AC input and an AC output; a voltage conversion circuitry disposed in the casing, wherein the AC input is connected to the voltage conversion circuitry, the input voltage is converted by the voltage conversion circuitry and connected to the AC output, wherein the voltage conversion circuitry includes a low power voltage conversion circuitry and a high power voltage conversion circuitry; outputs of the low power voltage conversion circuitry and the high power voltage conversion circuitry are connected in parallel, and then connected to the AC output; the low power voltage conversion circuitry has a core transformer, the voltage waveform after voltage conversion is called a first waveform; the high power voltage conversion circuitry has a bidirectional thyristor (TRIAC), the voltage waveform after voltage conversion is called a second waveform; an operating current circuitry of the low power voltage conversion circuitry includes one or more than one current overload protectors, when the required power of a connected external load is low power, the current passes through the low power voltage conversion circuitry and the current overload protector, the output voltage waveform is the first waveform; when the required power of the connected external load is high, the current overload protector reduces or restricts the output of the first waveform, so that the second waveform is actuated and output.

More particularly, wherein both ends of the current overload protector are connected to one or more than one resistor in parallel; when the current overload protector reduces or restricts the output of the first waveform, the first waveform is connected with the second waveform through the resistor output.

More particularly, wherein both ends of the current overload protector are connected to one or more than one indicator light in parallel; when the current overload protector reduces or restricts the output of the first waveform, the voltage difference between both ends of the indicator light is increased, presenting the light on.

More particularly, wherein the current overload protector is resettable fuse PTC, resemble fuse PPTC, circuit breaker or thermostat switch.

More particularly, wherein the AC input is a power plug; the AC output is a power socket.

In comparison to the existing technology, the present invention has the following effects:

When the load of electronic product connected to the AC output of the present invention is lower than the consumption power of this low wattage transformer, the current overload protector can work normally, the output voltage waveform is the voltage waveform of low wattage transformer. If the load of the electronic product connected to the AC output of the present invention is higher than the allowable consumption power of low wattage transformer, the current overload protector reduces or restricts the output of the first waveform, the voltage waveform of AC output of the present invention turns into the voltage waveform of high wattage converter. This design can implement the safety by using the automatic switch of current overload protector.

### BRIEF DESCRIPTION OF THE DRAWINGS

FIG. 1 is a schematic view of the present invention;

FIG. 2 is a circuit schematic view of Embodiment 1 of the present invention;

FIG. 3 is another circuit schematic view of embodiment 1 of the present invention;

FIG. 4 is a circuit schematic view of embodiment 2 of the present invention.

### DETAILED DESCRIPTION OF THE INVENTION

### Embodiment 1

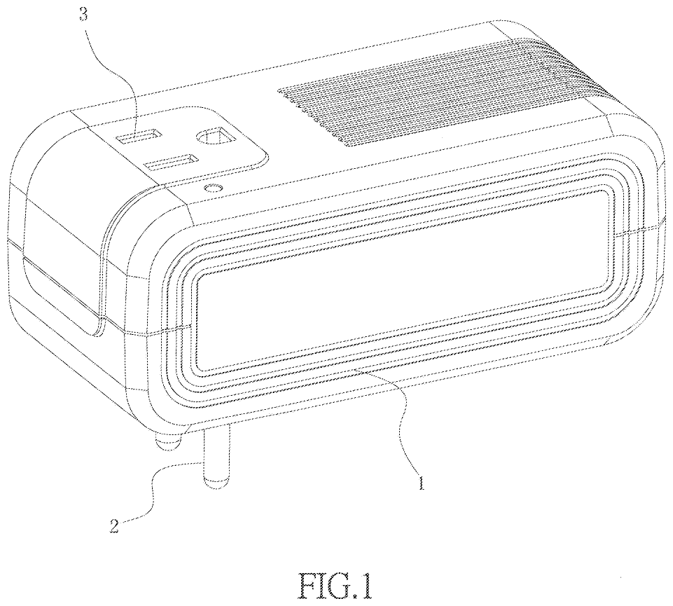

As shown in FIGS. 1 to 3, a portable voltage converter comprises a casing 1, an AC input 2 and an AC output 3, a voltage conversion circuitry 4 is disposed in the casing 1, the AC input 2 is connected to the voltage conversion circuitry 4, the input voltage is converted by the voltage conversion circuitry 4 and connected to the AC output 3. The AC input 2 is a power plug; the AC output 3 is a power socket.

The voltage conversion circuitry 4 is provided with a low power voltage conversion circuitry 41 and a high power voltage conversion circuitry 42. The outputs of the low power voltage conversion circuitry 41 and the high power voltage conversion circuitry 42 are connected in parallel, and then connected to the AC output 3. The low power voltage conversion circuitry 41 has a core transformer 411, the voltage waveform after voltage conversion is called a first waveform. The high power voltage conversion circuitry 42 has a bidirectional thyristor (TRIAC) 421, the voltage waveform after voltage conversion is called a second waveform. The operating current circuitry of low power voltage conversion circuitry 41 includes one or more than one current overload protector 412. When the required power of a connected external load is low power, the current passes through the low power voltage conversion circuitry 41 and the current overload protector 412, the output voltage waveform is the first waveform, the voltage difference between both ends of TRIAC 421 is not large enough to trigger the TRIAC 421, so there is no output of the second waveform. When the required power of the connected external load is high, the current overload protector 412 reduces or restricts the output of the first waveform, the voltage difference between both ends of TRIAC 421 is increased, the TRIAC 421 is triggered, and the second waveform is actuated and output. Therefore, the first waveform output is reduced and combined with the output of the second waveform. The first waveform provides a starting point of 0V as a control point for external load.

The AC input 2, low power voltage conversion circuitry 41 and AC output 3 comprise a low wattage transformer. The AC input 2, high power voltage conversion circuitry 42 and AC output 3 comprise a high wattage converter. The present invention combines a low wattage transformer with a high wattage converter to form a mixed voltage converter, and the line of low wattage transformer is connected to one or more than one current overload protector 412. The current overload protector 412 replaces the large sized manual switch or relay with complex circuitry, and implements the function of automatic switch, so that the overall size and cost of the present invention can be reduced, the market competition is enhanced. When the current overload protector 412 is in normal operation, if the input voltage waveform of AC input 2 is sine wave, the current passes through the low power voltage conversion circuitry 41 and the current overload protector 412, the output of the first waveform is also sine wave, both of the input voltage waveform and the output voltage waveform are the sine waves. Therefore, when the current overload protector 412 is in normal operation, if the input voltage waveform of AC input 2 is sine wave, the output voltage waveform is the same sine wave as the case only with traditional silicon steel sheet (EI) or magnetic core step-down transformer. When the current overload protector 412 is cut off, if the input voltage waveform of AC input 2 is also sine wave, the output voltage waveform of this AC output 3 is the same non-sine waveform as the case only with TRIAC switching circuit. To sum up, when the load of the electronic product connected to the AC output 3 of the present invention is lower than the consumption power of this low wattage transformer, the current overload protector 412 can work normally, the output voltage waveform is the voltage waveform of low wattage transformer. If the load of the electronic product connected to the AC output 3 of the present invention is higher than the allowable consumption power of low wattage transformer, the current overload protector 412 reduces or restricts the output of the first waveform, the voltage waveform of AC output 3 of the present invention turns into the voltage waveform of high wattage converter, it is the second waveform. This design can implement the safety by using the automatic switch of current overload protector 412.

The current overload protector is resettable fuse PTC, resettable fuse PPTC, circuit breaker or thermostat switch.

As a priority implementation example, the current overload protector 412 uses resettable fuse PTC. The resettable fuse is an overcurrent electronic protection component. The conventional fuse has overcurrent once only, it must be changed as soon as the fuse burnt out. The resettable fuse has dual functions of overcurrent and overheating-protection and automatic reset. The resettable fuse in normal operation is in low resistance state. When the short circuit or overload occurred, the heat generated by the high current through the resettable fuse forms high resistance state, the operating current decreases rapidly, so that the circuit is restricted and protected. As soon as the fault resolution, the resettable fuse is cool down again and recovered to the low resistance state, so that the circuit is protected, component change is unnecessary.

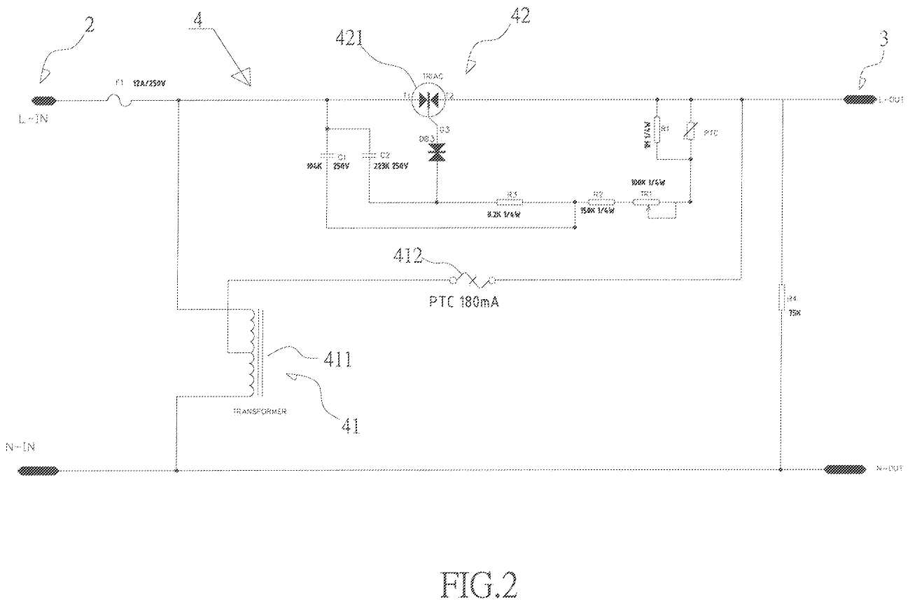

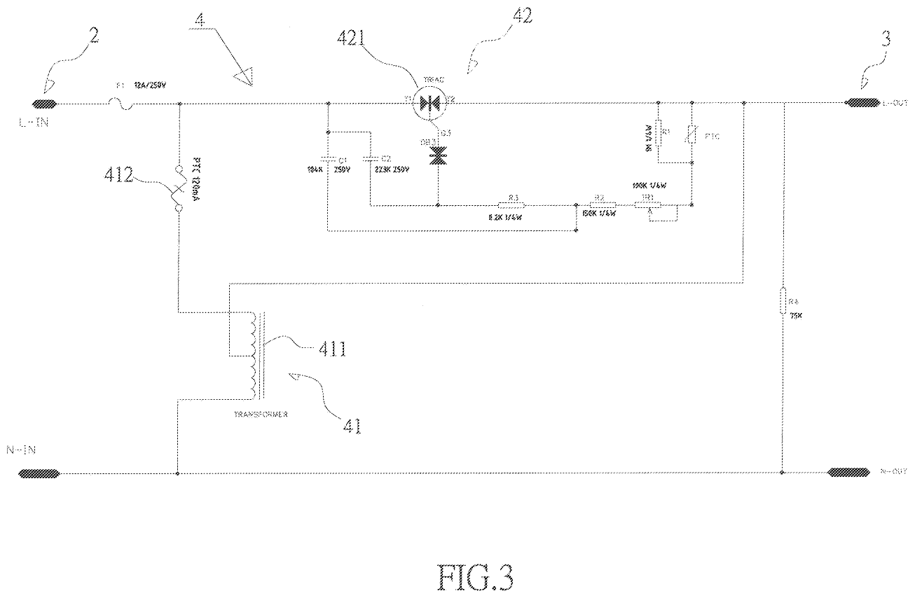

The resettable fuse PTC can be located in the output of the core transformer 411, as shown in FIG. 2. Certainly, the resettable fuse PTC can be located in the input of the core transformer 411 too, as shown in FIG. 3.

To sum up, the present invention enables the travelers to use the same electrical product in different countries with different voltages, its voltage conversion function provides both high wattage and low wattage voltage conversion functions, implementing automatic switching of high/low wattage, the utility range is larger than the existing products on the market, and it is more convenient to use.

### Embodiment 2

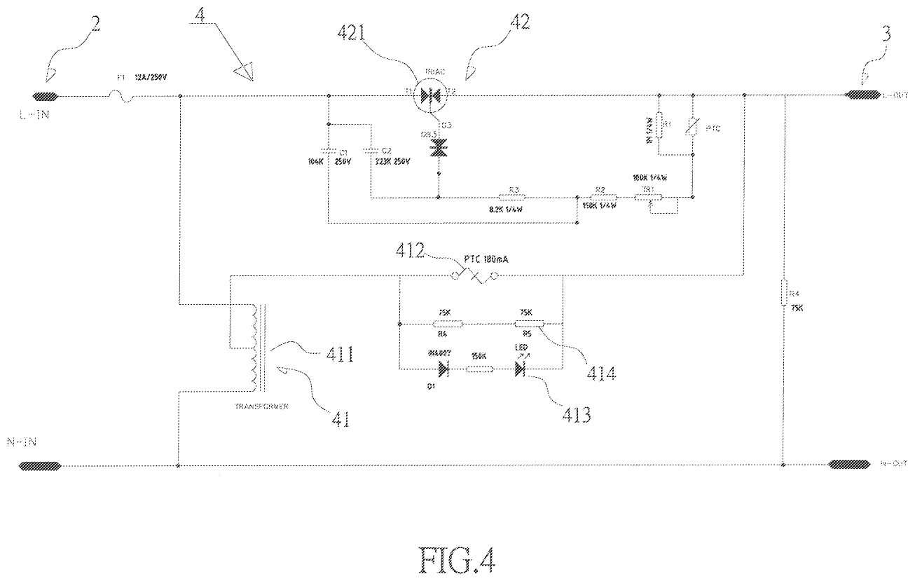

As shown in FIG. 4, the Embodiment 2 is modified based on the Embodiment 1, both ends of the current overload protector 412 are connected to one or more than one resistor 414 in parallel, when the current overload protector 412 reduces or restricts the output of the first waveform, the first waveform is combined with the second waveform through the resistor output, providing the 0V of waveform continuously; In this embodiment, the both ends of current overload protector 412 are connected to resistor R4 and resistor R5 in parallel. Both ends of the current overload protector 412 are connected to one or more than one indicator light 413 in parallel, when the current overload protector 412 reduces or restricts the output of the first waveform, the voltage difference between the both ends of the indicator light 413 is increased, presenting the light on, so as to remind the user of the operating state of the present invention. The indicator light 413 is a LED indicator light or a neon indicator light. When the indicator light is a LED light, it is connected to a diode D1 in series, so as to guarantee correct power polarity of LED indicator light.

Besides the above statement, other structures of the Embodiment 2 are identical with the structure of the Embodiment 1, which are not described anymore, and the Embodiment 2 has the same technical effect of the Embodiment 1.

I claim:

1. A portable voltage converter, comprising
a casing, an AC input and an AC output; a voltage conversion circuitry disposed in the casing, wherein the AC input is connected to the voltage conversion circuitry, the input voltage is converted by the voltage conversion circuitry and connected to the AC output,
wherein the voltage conversion circuitry includes a low power voltage conversion circuitry and a high power voltage conversion circuity; outputs of the low power voltage conversion circuitry and the high power voltage conversion circuitry are connected in parallel, and then connected to the AC output; the low power voltage conversion circuitry has a core transformer, the voltage waveform after voltage conversion is called a first waveform; the high power voltage conversion circuitry has a bidirectional thyristor (TRIAC), the voltage waveform after voltage conversion is called a second waveform; an operating current circuitry of the low power voltage conversion circuitry includes one or more than one current overload protectors, when the required power of a connected external load is low power, the current passes through the low power voltage conversion circuity and the current overload protector, the output voltage waveform is the first waveform; when the required power of the connected external load is high, the current overload protector reduces or restricts the output of the first waveform, so that the second waveform is actuated and output.

2. The portable voltage converter defined in claim 1, wherein both ends of the current overload protector are connected to one or more than one resistor in parallel; when the current overload protector reduces or restricts the output of the first waveform, the first waveform is connected with the second waveform through the resistor output.

3. The portable voltage converter defined in claim 1, wherein both ends of the current overload protector are connected to one or more than one indicator light in parallel; when the current overload protector reduces or restricts the output of the first waveform, the voltage difference between both ends of the indicator light is increased, presenting the light on.

4. The portable voltage converter defined in claim 1, wherein the current overload protector is resettable fuse PTC, resettable fuse PPTC, circuit breaker or thermostat switch.

5. The portable voltage converter defined in claim 1, wherein the AC input is a power plug; the AC output is a power socket.
